(19) United States
(12) Patent Application Publication
(10) Pub. No.: US 2023/0370058 A1
(43) Pub. Date: Nov. 16, 2023

(54) RANDOM NUMBER GENERATOR WITH FD-SOI LVT DOUBLE-GATE TRANSISTORS POLARISED IN THE FBB MODE

(71) Applicant: COMMISSARIAT A L'ENERGIE ATOMIQUE ET AUX ENERGIES ALTERNATIVES, Paris (FR)

(72) Inventors: Licinius-Pompiliu BENEA, Grenoble Cedex 09 (FR); Romain WACQUEZ, Grenoble Cedex 09 (FR); Florian PEBAY-PEYROULA, Grenoble Cedex 09 (FR); Vincent PUYAL, Grenoble Cedex 09 (FR); Mikael CARMONA, Grenoble Cedex 09 (FR); Michael PELISSIER, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/317,349

(22) Filed: May 15, 2023

(30) Foreign Application Priority Data
May 16, 2022 (FR) 22 04633

(51) Int. Cl. H03K 17/14; H03K 3/84; H03K 3/03; G06F 7/58

(52) U.S. Cl. CPC H03K 17/145; H03K 3/84; H03K 3/0315; G06F 7/588

(57) ABSTRACT

A random number generator including at least one ring oscillator comprising at least one inverter formed by at least two FDSOI LVT transistors, one being of the NMOS type and the other one being of the PMOS type, and further including a circuit for applying voltages on rear gates of the transistors configured to bias the transistors in the FBB mode.

### TECHNICAL FIELD

The invention relates to the field of random number generators (or TRNG standing for “True Random Number Generator”), advantageously applied to the field of cryptography.

### State of the Prior Art

In the field of cryptography, a TRNG is a fundamental circuit used in many cryptographic primitives (generation of session keys, digital signature, masking, etc.). It ensures the unpredictable nature of the outputs of the primitive. Unpredictability is one of the mechanisms guaranteeing the security level of a cryptographic primitive. A TRNG is composed by three main blocks:
a digitised entropy source, which forms a sampled physical randomness source;
a post-processing circuit intended, for example, to increase the rate of the entropy source or to correct some randomnesses, in particular, through the use of a pseudo-random number generator (or PRNG standing for “PseudoRandom Number Generator”);
an embedded test circuit intended to detect an anomaly in the operation of the TRNG and to transfer warnings to a control circuit of the TRNG.

The entropy source of the TRNG may be made based on a ring oscillator (or RO standing for “Ring Oscillator”). The entropy source is often formed by several ROs operating in parallel and whose digitised outputs are applied on inputs of an Exclusive-OR (XOR) circuit in order to obtain at the output of this XOR a unique series of bits with random values. The role of the XOR is to improve the randomness and the correlation of each series of bits derived from each RO, considered independently. The number of ROs connected in parallel is sized so that the generated randomness is compliant with the expected standards.

A RO is composed by one or more (an odd number) inverter(s), each composed by a NMOS transistor and a PMOS transistor. All inverters are connected to the same power supply voltage VDD and to the ground GND.

In the case of a TRNG made from one or more RO(s), the randomness source of the TRNG is the jitter of the RO(s), i.e. the discrepancy between the theoretical period and the actual period of the output signal of the or each RO.

In practice, the jitter is a randomness composed by several sources of noises the most prevailing two of which are the thermal noise and the flicker noise. The thermal noise is perfectly white, i.e. non-correlated, and therefore contributes in the generation of a perfectly unpredictable randomness. On the contrary, the flicker noise is a self-correlated noise which induces predictability in the jitter.

Several recent constraints applying to cryptography affect the design of TRNGs. For example, the use of TRNGs in the field of light cryptography (IoT standing for “Internet of Things”) imposes a greater connectivity and a lower electrical consumption of the TRNGs. The increase of attacks, in number and in power, also increases the requirement on the quality of the TRNGs. Finally, the use of quantum computers for cryptography suggests the emergence of cryptographic systems with more significant constraints.

To date, for the generated randomness to be compliant with the expected standards (typically an entropy higher than 0.997 according to the standards of the AIS31 defined by the German Federal Office for information security (BSI)), the solution consists in using a total number of RO in a TRNG that is enough to meet these standards. Nonetheless, this solution is not satisfactory given the recent constraints exposed before. A physical model statistically describing the operation of the TRNG is required.

### DISCLOSURE OF THE INVENTION

Thus there is a need to provide a random number generator, or TRNG, having a better assessment of the entropy which is calculated from the thermal component alone of the jitter, the other noise sources introducing errors in the calculation of the entropy.

For this purpose, one embodiment provides a random number generator, or TRNG, including at least one ring oscillator comprising at least one inverter formed by at least two FDSOI (“Fully Depleted Silicon-On-Insulator”) LVT (“Low Voltage Threshold”) transistors, one being of the NMOS type and the other one being of the PMOS type, further including a circuit for applying voltages on rear gates of the transistors configured to polarise the transistors in the FBB (“Forward Body Bias”) mode.

The direct polarisation of the wells of the transistors of the RO of the TRNG allows lowering the threshold voltage of these transistors. Yet, surprisingly and unexpectedly, this lowering of the threshold voltage of the transistors is reflected by a decrease in the flicker, or twinkle, noise for the same number of periods, which results in a shift of the point where the proportion of the thermal noise is maximum towards a larger number of periods. This results in increasing the quality of the calculation of the entropy of the signal outputted by the RO for a given number of oscillations, or change of values of this signal.

The FD-SOI type transistors are made in a FD-SOI type substrate having the particularity of having a silicon superficial layer in which the conduction channel and the source and drain regions of the transistors are formed, a final thickness of this channel being comprised between about 5 nm and 10 nm. The FD-SOI type substrate also includes a buried dielectric layer, or BOX (“Buried Oxide”), whose thickness is for example comprised between about 10 nm and 145 nm.

The transistors are of the LVT type, i.e. are such that the NMOS-type transistor(s) include(s), at the rear face and in contact with the BOX, a n-doped semiconductor well forming the rear gate(s) of these transistors, and that the PMOS-type transistor(s) include(s), at the rear face and in contact with the BOX, a p-doped semiconductor well forming the rear gate(s) of these transistors.

The polarisation of the transistors in the FBB mode means that the transistors are polarised, on their rear gate, such that the polarisation voltage applied on the rear gate of the NMOS transistor, or of each NMOS transistor, is positive and that the polarisation voltage applied on the rear gate of the PMOS transistor, or of each PMOS transistor, is negative.

The TRNG may be used in various fields, in particular that of embedded cryptography, for example in the fields of defence, industry, general-public electronics, etc.

In an advantageous embodiment, the random number generator may further include a circuit for detecting the maximum of the thermal noise present in a jitter of an output signal of the ring oscillator with respect to the flicker noise and to the quantisation noise present in the jitter of the output signal of the ring oscillator, configured to implement the following steps:
calculating an Allan variance V of the rise or descent times of the output signal of the ring oscillator according to the size of a measured sample corresponding to a number of oscillations N of the output signal of the ring oscillator;
calculating a quadratic approximation Vₐₚₚ of the previously-calculated Allan variance V, in the form of an equation of the type Vₐₚₚ=a₀+a₁·N+a₂·N²;
calculating a number of oscillations N_{th_max} of the output signal of the ring oscillator for which the thermal noise of the jitter of said output signal is maximised with respect to the flicker noise and to the quantisation noise of the jitter of said output signal, such that N_{th_max}=\sqrt{a₀/a₂};
controlling the ring oscillator such that the number of oscillations of the output signal of the ring oscillator is equal to N_{th_max}.

Advantageously, the circuit for applying voltages on the rear gates of the transistors may be configured to apply, on the rear gate of the PMOS transistor, a polarisation voltage with a value opposite to that applied on the rear gate of the NMOS transistor.

Advantageously, the circuit for applying voltages on the rear gate of the transistors may be configured to apply, on the rear gate of the NMOS transistor, a polarisation voltage with a value equal to a maximum limit value that the NMOS transistor withstands, and on the rear gate of the PMOS transistor, a polarisation voltage with a value equal to a minimum limit value that the PMOS transistor withstands.

### BRIEF DESCRIPTION OF THE DRAWINGS

The present invention will be better understood upon reading the description of embodiments given for purely indicative and non-limiting purposes with reference to the appended drawings wherein:

FIG. 1 schematically shows blocks composing a random number generator according to a particular embodiment;

FIG. 2 schematically shows an embodiment of a ring oscillator and other circuits of the random number generator;

FIG. 3 schematically shows two FDSOI LVT double-gate CMOS transistors forming an inverter stage of the ring oscillator of the random number generator;

FIG. 4 shows curves of the Allan variance of the jitter of the output signal of an embodiment of the ring oscillator of the random number generator as a function of the number of oscillations of this signal for different voltages applied on the rear gate of the transistors of the ring oscillators;

FIG. 5 shows the thermal noise proportion with respect to the other noises in the jitter of the output signal of an embodiment of the ring oscillator of the random number generator as a function of the number of oscillations of this signal.

Identical, similar or equivalent portions of the different figures described hereinafter bear the same reference numerals so as to facilitate switching from one FIG. to another.

The different portions shown in the figures are not necessarily plotted according to a uniform scale, to make the figures more readable.

The different possibilities (alternatives and embodiments) must be understood as not being mutually exclusive and can be combined with one another.

### DETAILED DISCLOSURE OF PARTICULAR EMBODIMENTS

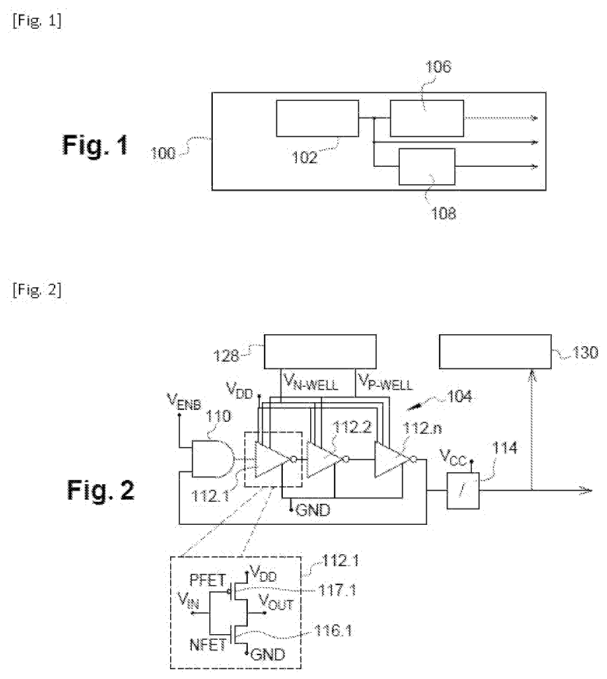

A random number generator, TNRG, 100 according to a particular embodiment is described hereinbelow in connection with FIG. 1.

The TRNG 100 includes a first circuit 102 forming a digitised entropy source, i.e. a sampled physical randomness source. This first circuit 102 includes at least one ring oscillator, RO, 104. When the first circuit 102 includes several ROs 104 operating in parallel, the digitised outputs of the RO 104 are preferably applied on inputs of an exclusive-OR (XOR) circuit in order to obtain at the output of this XOR a unique series of bits with random values.

The TRNG 100 also includes a post-processing circuit 106 receiving at the input the signal outputted by the first circuit 102 and intended to increase the rate or to modify the output of the entropy source. For example, the circuit 106 includes a PRNG.

The TRNG 100 also includes an embedded test circuit 108 receiving at the input the signal outputted by the first circuit 102 and intended to detect an anomaly in the operation of the TRNG 100 and to output possible warning signals.

Details of making of the circuits 106 and 108 are described for example in the document W. Killmann et al., AIS20/AIS31. “A Proposal for: Functionality Classes for Random Number Generators”, version 2.0.

An embodiment of the RO 104, or of one of the RO 104, of the TRNG 100 is described hereinbelow in connection with FIG. 2.

In this example, the RO 104 includes an AND gate 110 provided with a first input on which an operating voltage V_{ENB} with a value corresponding to that of a logic state “1” is applied. The output of the AND gate 110 is coupled to the input of at least one inverter. In the example of FIG. 2, the output of the AND gate 110 is coupled to the input of a first inverter 112.1 belonging to a chain of n inverters coupled together in series, n corresponding to an odd number. In the example of FIG. 2, the second inverter 112.2 and the last inverter 112.n of this chain are also shown. The output of the last inverter 112.n is coupled to a second input of the AND gate 110 which thus achieves the loopback of the RO 104. When the RO includes a unique inverter, the output of this unique inverter is coupled to the second input of the AND gate 110.

In the embodiment of FIG. 2, the RO 104 also includes a frequency divider 114 comprising an input coupled to the output of the last inverter 112.n (or of the unique inverter if the RO 104 includes only one inverter). The output of the frequency divider 114 forms the output of the RO 104. This frequency divider 114 allows performing the acquisition of the output voltage of the last inverter 112.n (or of the unique inverter) on frequencies lower than the natural frequency of the signal outputted by the last inverter 112.n (or of the unique inverter) of the RO 104.

Alternatively, the RO 104 may include no AND gate 100 and/or frequency divider 114. Thus, the RO 104 may be formed by at least one inverter 112. Furthermore, it is also possible that the RO 104 includes one or more delay line(s) replacing one or more inverter stage(s), or that the RO 104 includes a NAND gate coupled to an even number of inverter stages and/or delay lines.

The inverter of each of the inverters RO 104 is formed by at least two FD-SOI LVT double-gate CMOS transistors intended to be polarised in the FBB mode during the operation of the TRNG 100. FIG. 2 schematically shows the transistors forming the first inverter 112.1 (the other inverters 112.2 and 112.n being herein formed by transistors identical to those forming the first inverter 112.1). The NMOS transistor of the first inverter 112.1 is designated by the reference 116.1 and the PMOS inverter is designated by the reference 117.1. All inverters (and therefore all of the transistors forming these inverters) are connected to the same power supply voltage VDD and the ground GND.

The rear gates of the MOSFET transistors forming the inverters are controlled by voltages V_{N-WELL} and V_{P-WELL} applied on these.

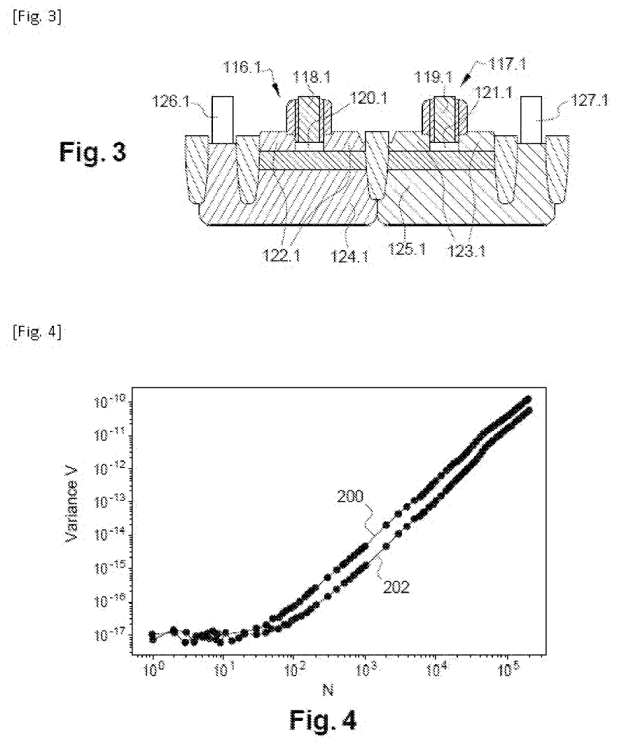

FIG. 3 schematically shows a profile view of the two transistors 116.1, 117.1 forming the first inverter 112.1. Each of these transistors 116.1, 117.1 includes a gate 118.1, 119.1, a channel region 120.1, 121.1 and source and drain regions 122.1, 123.1 (N doped for the NMOS transistor 116.1 and P doped for the PMOS transistor 117.1). These transistors 116.1, 117.1 being of the FD-SOI type, the channel regions 120.1, 121.1 and the source and drain regions 122.1, 123.1 are formed in the semiconductor superficial layer of the FD-SOI substrate in which these transistors 116.1, 117.1 are made. Each of the transistors 116.1, 117.1 includes a rear gate formed by a doped semiconductor region 124.1, 125.1 formed under the buried dielectric layer of the FD-SOI substrate. The transistors 116.1, 117.1 being made in a LVT configuration, the region 124.1 forming the rear gate of the NMOS transistor 116.1 is N doped, and the region 125.1 forming the rear gate of the PMOS transistor 117.1 is P doped. Each of the transistors 116.1, 117.1 also includes a rear gate contact 126.1, 127.1 allowing applying the voltages V_{N-WELL} and V_{P-WELL} respectively on the regions 124.1, 125.1.

The TRNG 100 also includes a circuit 128 for applying voltages V_{N-WELL} and V_{P-WELL} on the rear gate contacts 126.1 and 127.1 of the transistors 116.1, 117.1, configured to polarise the transistors 116.1, 117.1 in the FBB mode. This circuit 128 is shown in FIG. 2. Such a polarisation of the voltages 116.1, 117.1 allows lowering their threshold voltage, thereby increasing the performances of the RO 104 by increasing its oscillation frequency.

Advantageously, the circuit 128 is configured to apply, on the rear gate of the PMOS transistor 117.1, a polarisation voltage with a value opposite to that applied on the rear gate of the NMOS transistor 116.1. Advantageously, these polarisation voltages have values equal to maximum (for the NMOS transistor) and minimum (for the PMOS transistor) limit values that the transistors 116.1, 117.1 withstand. For example, the voltage V_{N-WELL} is equal to 1.8 V and the voltage V_{P-WELL} is equal to −1.8 V. Furthermore, the values of the voltages V_{N-WELL} and V_{P-WELL} are selected such that V_{N-WELL}−V_{P-WELL}>−0.6 V in order not to make the diode formed between the doped regions 124.1 and 125.1 conducting, and such that V_{N-WELL}−V_{P-WELL}<6 V in order not to trigger the breakdown effect of this diode.

The TRNG 100 also includes a circuit 130 for detecting the maximum of the thermal noise present in the jitter of the output signal of the RO 104 with respect to the flicker noise and to the quantisation noise present in the jitter of the output signal of the RO 104.

The circuit 130 calculates an Allan variance V of the rise and descent times (also called “flip times”) of the signal outputted by the RO 104 according to the size of the measured sample, i.e. the number of oscillations N of the output signal. The calculated variance V corresponds to an Allan variance, as described for example in the document by P. Haddad et al., “On the assumption of mutual independence of jitter realisations in

P-TRNG stochastic models.”, Proceedings of Design, Automation and Test in Europe DATE 2014, March 2014, Dresden, Germany, pp. 1-6, or else in the document E. N. Allini et al., “Evaluation and monitoring of free running oscillators serving as source of Randomness”, IACR Transactions on Cryptographic Hardware and Embedded Systems I, 2018, Issue 3, pp. 214-242.

The curve 200 shown in FIG. 4 represents the calculated Allan variance V when V_{N-WELL}=V_{P-WELL}=0 V, and the curve 202 represents this same Allan variance V when V_{N-WELL}=2 V and V_{P-WELL}=−2 V.

The calculated Allan variance V significantly depends on the characteristic parameters of the thermal noise, of the quantisation noise and of the flicker noise present in the jitter of the output signal of the RO 104. Indeed, this Allan variance V is quadratic depending on the size of the measured sample (i.e. of the number of oscillations of the output signal of the considered RO 104). In this Allan variance V, the linear component corresponds to the thermal noise, the quadratic component corresponds to the flicker noise, and the constant component corresponds to the quantisation noise (the noise floor). Consequently, by estimating the coefficients of these components of the calculated Allan variance V, it is possible to deduce therefrom the proportion between the flicker, quantisation and thermal noises in the jitter of the output signal of the RO 104.

Thus, starting from the previously-calculated Allan variance V, the circuit 130 then calculates a quadratic approximation, called Vₐₚₚ, of the previously-calculated Allan variance V, in the form of an equation of the type Vₐₚₚ=a₀+a₁·N+a₂·N². In this equation, the term a₀ is representative of the quantisation noise, the term a₁ is representative of the thermal noise, and the term a₂ is representative of the flicker noise.

To determine the number of oscillations of the output signal of the RO 104 for which the thermal noise is maximised with respect to the flicker noise and to the quantisation noise, the circuit 130 calculates the number of oscillations N_{th_max} of the RO 104 such that N_{th_max}=\sqrt{a₀/a₂}.

By making the RO 104 operate afterwards such that the output signal of the RO 104 includes a number of oscillations N=N_{th_max}, the contribution of the thermal noise in the jitter of the signal generated by the RO 104 is maximised with respect to the flicker and quantisation noises, which allows guaranteeing greater entropy of the TRNG 100. When N is less than N_{th_max}, the lower is N, the more significant will be the quantisation noise with respect to the thermal noise. When N is greater than N_{th_max}, the greater is N, the more significant will be the flicker noise with respect to the thermal noise.

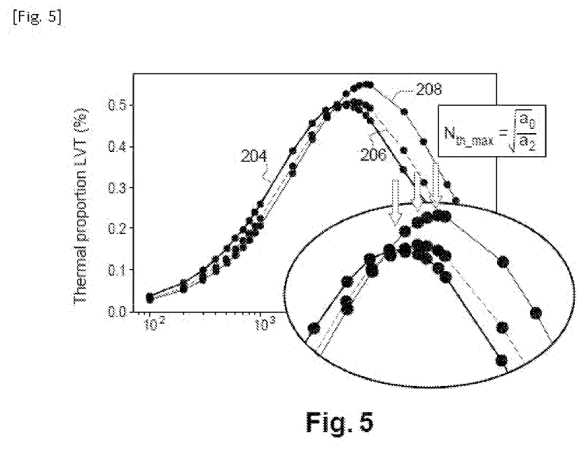

The curves 204, 206 and 208 shown in FIG. 5 represent, for rear gate voltages V_{N-WELL} and V_{P-WELL} equal to 0 V (curve 204), equal to 1 V and −1 V (curve 206) and equal to 2 V and −2 V (curve 208), the proportion of the thermal noise among all of the noise of the signal generated by RO 104. In these curves, the calculation of N=N_{th_max} for each of these three configurations corresponds to the value of N for which the apex of each of these curves is reached (with a thermal noise portion of about 50%).

As a variant of the embodiment described hereinabove, when the RO 104 includes a chain with an odd number of inverters coupled in series, it is possible that one or more inverter(s) of this chain is replaced by another electronic circuit performing a function of inverting the signal applied at its input. Conversely, at least one amongst the inverters of this chain is formed by at least two FDSOI LVT double-gate CMOS transistors intended to be polarised in the FBB mode as described before.

1. A random number generator including at least one ring oscillator comprising:
at least one inverter formed by at least two FDSOI LVT transistors, one being of the NMOS type and the other one being of the PMOS type;
a circuit for applying voltages on rear gates of the transistors configured to polarise the transistors in the FBB mode.

2. The random number generator according to claim 1, further including a circuit for detecting the maximum of the thermal noise present in a jitter of an output signal of the ring oscillator with respect to the flicker noise and to the quantisation noise present in the jitter of the output signal of the ring oscillator, configured to implement the following steps:
calculating an Allan variance V of the rise or descent times of the output signal of the ring oscillator according to the size of a measured sample corresponding to a number of oscillations N of the output signal of the ring oscillator;
calculating a quadratic approximation Vₐₚₚ of the previously-calculated Allan variance V, in the form of an equation of the type Vₐₚₚ=a₀+a₁·N+a₂·N²;
calculating a number of oscillations N_{th_max} of the output signal of the ring oscillator for which the thermal noise of the jitter of said output signal is maximised with respect to the flicker noise and to the quantisation noise of the jitter of said output signal, such that N_{th_max}=\sqrt{a₀/a₂};
controlling the ring oscillator such that the number of oscillations of the output signal of the ring oscillator is equal to N_{th_max}.

3. The random number generator according to claim 1, wherein the circuit for applying voltages on the rear gates of the transistors is configured to apply, on the rear gate of the PMOS transistor, a polarisation voltage with a value opposite to that applied on the rear gate of the NMOS transistor.

4. The random number generator according to claim 3, wherein the circuit for applying voltages on the rear gate of the transistors is configured to apply, on the rear gate of the NMOS transistor, a polarisation voltage with a value equal to a maximum limit value that the NMOS transistor withstands, and on the rear gate of the PMOS transistor, a polarisation voltage with a value equal to a minimum limit value that the PMOS transistor withstands.
